(19) United States
(12) Patent Application Publication
(10) Pub. No.: US 2005/0221779 A1
(43) Pub. Date: Oct. 6, 2005

(54) AGC circuit

(76) Inventor: Taiwa Okanobu, Tokyo (JP)

Correspondence Address: Cooper & Dunham LLP, 1185 Avenue of the Americas, New York, NY, 10036, US

(21) Appl. No.: 11/093,416

(22) Filed: Mar. 30, 2005

(30) Foreign Application Priority Data
Apr. 6, 2004 (JP) P2004-111692

(51) Int. Cl. H04B 17/02; H04B 1/06; H04B 7/00

(52) U.S. Cl. 455/253.2; 455/234.1; 375/345

(57) ABSTRACT

An automatic gain control (AGC) circuit includes a number of attenuation circuits connected in series relative to a reception signal, a of variable gain amplifiers to which the reception signal and each output signal from the attenuation circuits are fed, respectively, a signal deriving circuit connected to output terminals of the variable gain amplifiers for deriving a level-controlled output signal, and a control current generating circuit for generating a control current having a predetermined characteristic out of first and second AGC voltages, wherein the control current outputted from the control current generating circuit is supplied to the variable gain amplifiers as a control signal for switching an operation thereof and for controlling a gain thereof, and a feedback control current corresponding to the control current is performed by the control current generating circuit.

### CROSS REFERENCES TO RELATED APPLICATIONS

The present invention contains subject matter related to Japanese Patent Application JP 2004-111692 filed in the Japanese Patent Office on Apr. 6, 2004, the entire contents of which being incorporated herein by reference.

### BACKGROUND OF THE INVENTION

1. Field of the Invention

The present invention relates to an AGC circuit of a radio receiver.

2. Description of Related Art

An AGC (Automatic Gain Control) circuit at a high frequency stage of a radio receiver may be configured such as shown in FIG. 15. In FIG. 15, a reference numeral 1 represents an antenna tuning circuit, a reference numeral 2 represents a high frequency amplifier, and a reference numeral 3 represents a mixer circuit. The high frequency amplifier 2 is constituted of attenuator circuits 2A to 2C, variable gain amplifiers 2D to 2G, and an adder circuit 2H.

Operation and non-operation of the amplifiers 2D to 2G are controlled by an AGC voltage, and a gain during the operation is controlled in a manner such as shown in FIG. 16. Namely, if the level of a reception signal SRX is within a range (1) shown in FIG. 16 (that is, when the reception level is low), the reception signal SRX is derived from the amplifier 2D, and is supplied to the mixer circuit 3 via the adder circuit 2H, in which the AGC is performed by controlling the gain of the amplifier 2D. If the level of the reception signal SRX is within a range (2) in FIG. 16, the reception signal SRX attenuated by the attenuator circuit 2A is derived from the amplifier 2E, and is supplied to the mixer circuit 3 via the adder circuit 2H, in which the AGC is performed by controlling the gain of the amplifier 2E.

If the level of the reception signal SRX is within a range (3), the reception signal SRX attenuated by the attenuator circuits 2A and 2B is derived from the amplifier 2F, and is supplied to the mixer circuit 3 through the adder circuit 2H, in which the AGC is performed by controlling the gain of the amplifier 2F. If the level of the reception signal SRX is within a range (4), the reception signal SRX attenuated by the attenuator circuits 2A, 2B and 2C is derived from the amplifier 2G, and is supplied to the mixer circuit 3 through the adder circuit 2H, in which the AGC is performed by controlling the gain of the amplifier 2G.

With this AGC circuit, the reception signal SRX can be subjected to the AGC in a wide range from a very small level to a large level. The reception signal SRX having a large level corresponding to the attenuation amounts of the attenuator circuits 2A to 2C can be processed while a low distortion is maintained. This is an excellent method as a method of controlling the gain at a high frequency stage. For a prior art documentation, refer to, for example, Japanese Laid-open Patent Application No. 2001-53564.

### SUMMARY OF THE INVENTION

Although the high frequency amplifier 2 constructed as above has a low distortion, an S/N (Signal to Noise) ratio of the reception signal SRX is lowered by an amount corresponding to a level lowered by the attenuator circuits 2A to 2C. In order to improve the S/N ratio, it is necessary to supply a large reception signal SRX to the high frequency amplifier 2, although the distortion increases somewhat. Under the reception conditions that a strong interference wave exists, there arises a problem of an S/N ratio lowered rather by interference signals. Among interferences by broadband signals such as in digital broadcasting, mutual modulation distortion by interference signals is a practical problem.

Depending upon an AGC voltage generating method, even under the reception conditions that interference waves pose no problem, as a reception signal SRX becomes large, the level is controlled so that the S/N ratio does not become better than that at the reception level at which the gain starts being lowered.

The present invention solves the above-described problems.

The present invention provides an AGC circuit which comprises: a high frequency amplifier constituted of a variable gain amplifier; a first conversion circuit for converting a first AGC voltage into a first control current having predetermined characteristics; and a second conversion circuit for converting a second AGC voltage into a second control current having the predetermined characteristics, wherein the first and second control currents are fed back to the variable gain amplifier constituting the high frequency amplifier, as a gain control signal.

### BRIEF DESCRIPTION OF THE DRAWINGS

FIG. 1 is a connection diagram of a receiver according to an embodiment of the present invention;

FIG. 2 is a connection diagram of a high frequency amplifier of the receiver shown in FIG. 1;

FIG. 3 is a connection diagram of an attenuator circuit of the high frequency amplifier shown in FIG. 2;

FIGS. 4A and 4B are diagrams showing the characteristics of the high frequency amplifier shown in FIG. 2;

FIG. 5 is a connection diagram of a control current generating circuit of the receiver shown in FIG. 1;

FIG. 6 is a connection diagram of a logarithmic compression circuit of the control current generating circuit shown in FIG. 5;

FIG. 7 is a connection diagram of another logarithmic compression circuit of the control current generating circuit shown in FIG. 5;

FIG. 8 is a connection diagram of a switching control circuit of the control current generating circuit shown in FIG. 5;

FIG. 9 is a diagram showing the characteristics of the logarithmic compression circuit shown in FIG. 6;

FIG. 10 is a connection diagram of a modification of the logarithmic compression circuit shown in FIG. 7;

FIG. 11 is a connection diagram of a modification of the logarithmic compression circuit shown in FIG. 8;

FIG. 12 is a connection diagram of a modification of the control current generating circuit of the receiver shown in FIG. 1;

FIG. 13 is a connection diagram of a modification of the logarithmic compression circuit of the control current generating circuit shown in FIG. 12;

FIG. 14 is a connection diagram of the switching control circuit of the control current generating circuit shown in FIG. 12;

FIG. 15 is a block diagram showing an example of a high frequency amplifier; and

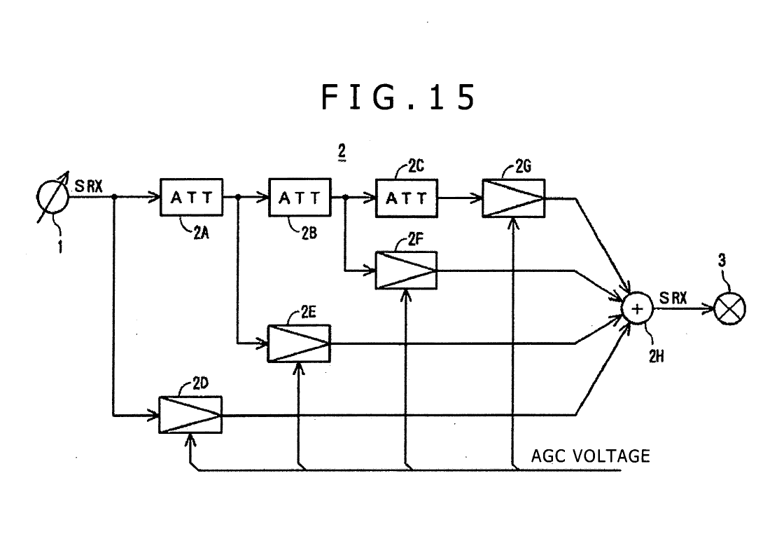

FIG. 16 is a diagram showing the characteristics of the high frequency amplifier shown in FIG. 15.

### DESCRIPTION OF THE PREFERRED EMBODIMENTS

[1] Receiver

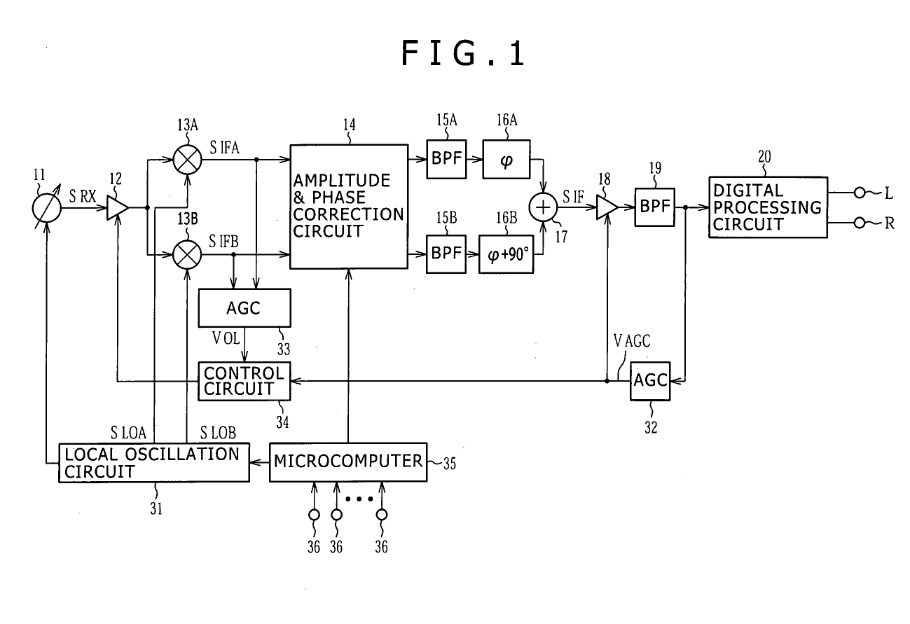

FIG. 1 shows an example of a receiver.

This receiver is of a so-called low IF (Intermediate Frequency) system in which an intermediate frequency is set much lower than a reception frequency by setting a local oscillation frequency near to the reception frequency. A reception signal is frequency-converted into a pair of orthogonal intermediate frequency signals, and the image characteristics are improved by phase processing.

Namely, a reception signal SRX having a target reception frequency is picked up from an antenna tuning circuit 11 of an electronic tuning type, and this reception signal SRX is supplied to a pair of mixer circuits 13A and 13B via a high frequency amplifier 12. A local oscillation circuit 31 is constituted of a PLL (Phase Locked Loop) circuit which generates two signals SLOA and SLOB having phases different by 90° and a frequency near to the frequency of the reception signal SRX (e.g., in the case of a receiver for a digital audio broadcasting, a frequency higher than the reception frequency by 500 kHz). The signals SLOA and SLOB are supplied as local oscillation signals to the mixer circuits 13A and 13B, respectively.

The mixer circuits 13A and 13B frequency-divide the reception signal SRX into a pair of intermediate frequency signals SIFA and SIFB by using the local oscillation signals SLOA and SLOB, respectively. In this case, each of the intermediate frequency signals SIFA and SIFB contains signal component of a desired frequency (target signal components) and signal component of an image frequency. For the purposes of simplicity, in the following description, the signal components of a desired frequency are called as the intermediate frequency signals SIFA and SIFB, and the signal components of the image frequency are called as image components.

Since the local oscillation signals SLOA and SLOB have a phase difference of 90°, the intermediate frequency signals SIFA and SIFB are orthogonal at a phase difference of 90°, and the image components are orthogonal at a phase difference of 90° in the opposite relation to the intermediate frequency signals SIFA and SIFB.

A portion of a control voltage to be applied to a variable capacitor diode of a VCO (not shown) of the PLL circuit is derived from the PLL circuit constituting the local oscillation circuit 31, and this control voltage is supplied as a tuning voltage to the tuning circuit 11 to tune in the reception signal SRX.

The intermediate frequency signals SIFA and SIFB (and image components) from the mixer circuits 13A and 13B are supplied to an amplitude and phase correction circuit 14 which corrects a relative amplitude error and phase error of the intermediate frequency signals SIFA and SIFB. The error-corrected intermediate frequency signals SIFA and SIFB are supplied to phase shift circuits 16A and 16B via band-pass filters 15A and 15B. The phase shift circuits 16A and 16B shift the phases, for example, in such a manner that the intermediate frequency signals SIFA and SIFB have the same phase and the image components have opposite phases. The intermediate frequency signals SIFA and SIFB after phase shifted are supplied to an calculation circuit 17 and added together. An intermediate frequency signal SIF while the image components is canceling out is outputted from the calculation circuit 17.

Next, the intermediate frequency signal SIF is supplied via an intermediate frequency amplifier 18 and a band-pass filter 19 to a digital processing circuit 20 which A/D converts the intermediate frequency signal and executes a predetermined digital process corresponding to the format of the reception signal SRX to output an audio signal.

The amplifiers 12 and 18 are made of variable gain amplifiers. A portion of the intermediate signal SIF from the band-pass filter 19 is supplied to an AGC voltage generating circuit 32 which generates an AGC voltage VAGC. The AGC voltage VAGC is supplied to the amplifier 18 as a gain control signal to conduct the AGC at the intermediate frequency stage.

The intermediate frequency signals SIFA and SIFB outputted from the mixer circuits 13A and 13B are also supplied to an AGC voltage generating circuit 33 relative to an excessive input which circuit generates an AGC voltage VOL when a reception level becomes too high due to interference waves or the like. This AGC voltage VOL is supplied to a control current generating circuit 34. An AGC voltage VAGC from an AGC voltage generating circuit 32 is also supplied to the control current generating circuit 34.

Although the details of the control current generating circuit 34 will be later described, this circuit generates a control current which changes with the supplied AGC voltages VAGC and VOL in the manner matching predetermined characteristics. This control current is supplied to the high frequency amplifier 12 as a control signal for the gain AV to conduct a delayed AGC at the high frequency stage.

Since the AGC voltage VOL is generated when the reception level becomes a rated value or higher due to interference waves and the like, this AGC voltage VOL is effective mainly for large level interference signals. Since the AGC voltage VAGC is generated from the intermediate frequency signal SIF processed by the AGC voltage VOL, this AGC voltage VAGC is effective mainly for a desired reception signal.

For the purposes of simplicity, in the following description, a voltage of an addition of these AGC voltage VAGC and the delayed AGC voltage VOL is represented by an AGC voltage VCTL. This addition is performed by giving a priority to the AGC voltage which requires to limit the gain of the amplifier 12 more than the other AGC voltage. An example of this addition is described later in [5].

The reception circuit as described above is fabricated to be one chip IC (integrated circuit), except the tuning circuit 11, a resonance circuit in the local oscillation circuit 31 and the digital processing circuit 20. The digital processing circuit 10 is also fabricated to be the same one chip IC.

A microcomputer 35 is provided as a system control circuit. Operation switches 36 such as a tuning switch is connected to the microcomputer 0.35. As the operation switches 36 are operated, the microcomputer 35 supplies a predetermined control signal to the local oscillation circuit 31 to change the oscillation frequency of the local oscillation signals SLOA and SLOB and the reception frequency.

For example, when the power is turned on, the microcomputer 35 supplies a correction control signal to the amplitude and phase correction circuit 14 which in turn is controlled, as described earlier, in such a manner that the image components contained in the intermediate frequency signals SIFA and SIFB are made to have the same amplitude and opposite phases so that the calculation circuit 17 can cancel out the image components.

[2] High Frequency Amplifier 12 and Its AGC Circuit

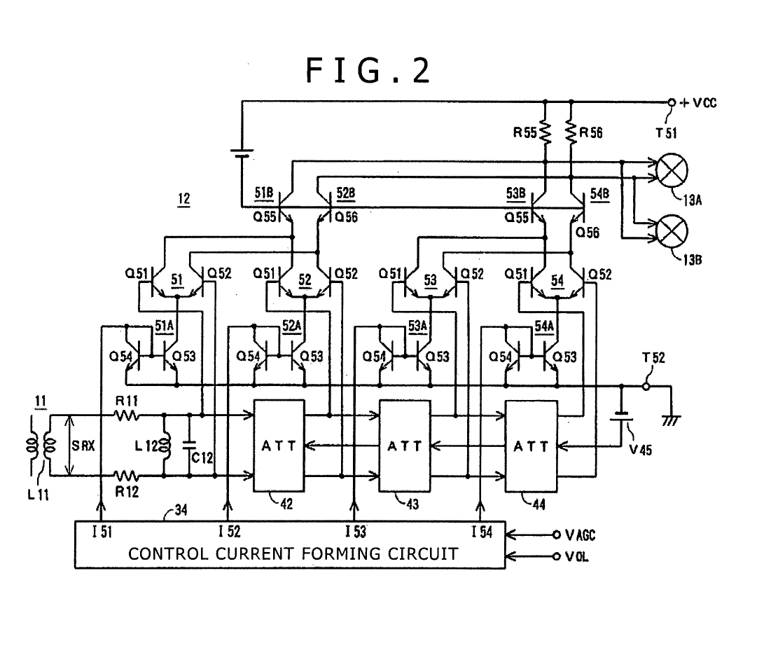

FIG. 2 shows an example of the high frequency amplifier 12 which is made of a variable gain amplifier to conduct an AGC. In this example, the high frequency amplifier 12 has cascade-connected three-stage attenuator circuits 42 to 44, a tuning circuit 11 and differential amplifiers 51 to 54 for picking up each output signal of the tuning circuit 11 and attenuator circuit 42 to 44.

More specifically, the tuning circuit 11 has a tuning coil whose secondary winding is represented equivalently by a serial circuit of an inductor L11, a resistor R11, a parallel circuit of an inductor L12 and a capacitor C12, and a resistor R12. A reception signal RSX is picked up at one ends of the resistors R11 and R12 in a balanced manner.

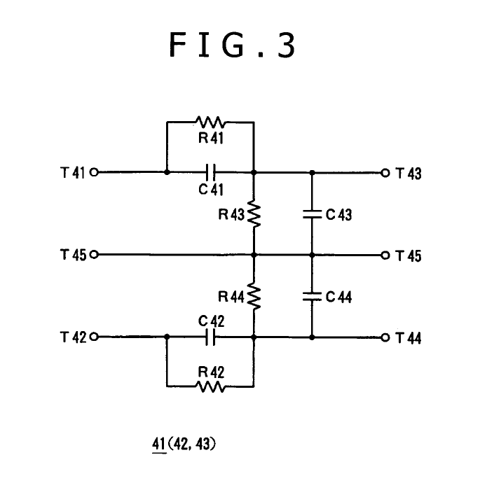

Each of the attenuator circuits 42 to 44 has a structure such as shown in FIG. 3. Namely, a parallel circuit of a capacitor C41 and a resistor R41 is connected between one input terminal T41 and one output terminal T43, and a parallel circuit of a resistor R43 and a capacitor C43 is connected between the output terminal T43 and a center terminal T45. A parallel circuit of a capacitor C42 and a resistor R42 is connected between the other input terminal T42 and the other output terminal T44, and a parallel circuit of a resistor R44 and a capacitor C44 is connected between the output terminal T44 and the center terminal T45.

The balanced-type attenuator circuits 42 to 44 are formed in this manner by the components R41 to R44 and C41 to C44.

These attenuator circuits 42 to 44 constitute balanced-type ladder attenuator circuits. In the attenuator circuits 42 to 44, the output terminals T43 and T44 of the attenuator circuit at the preceding stage are connected to the input terminals T41 and T42 of the attenuator circuit at the succeeding stage. The input terminals T41 and T42 are connected to the output sides of the resistors R11 and R12, and the terminals T45 are interconnected.

In each of the attenuator circuits 42 to 44, the following relations are satisfied:
C41×R41=C43×R43
C42×R42=C44×R44

If an attenuation amount of each of the attenuator circuits 42 to 44 is to be set equal, the values of the components R41 to R44 and C41 to C44 of the attenuator circuits 42 to 44 are set equal, the values of the resistors R43 and R44 of the attenuator circuit 44 are set to a half of the values of the resistors R43 and R44 of the attenuator circuit 42, and the values of the capacitors C43 and C44 of the attenuator circuit 44 are set to a double values of the capacitors C43 and C44 of the attenuator circuit 42.

By representing an attenuation amount per one stage of the attenuator circuits 42 to 44 by 1/n times (where n is an integer of 2 or larger), the following equations are satisfied:
R43/R41=2/(n−1)
C41/C43=2/(n−1)

For example, the attenuation amount per stage is 12 dB (=¼ times).

As shown in FIG. 2, the emitters of transistors Q51 and Q52 are connected to the collector of a constant current source transistor Q53 to constitute a differential amplifier 51, and the transistor Q53 and a transistor Q54 constitute a current mirror circuit 51A having a ground terminal T52 as a reference potential point. Similar to the differential amplifier 51, differential amplifiers 52 to 54 are constituted of transistors (Q51, Q52) to (Q51, Q52), and similar to the current mirror circuit 51A, current mirror circuits 52A to 54A are constituted of transistors (Q53, Q54) to (Q53, Q54).

The bases of the transistors Q51 and Q52 of the differential amplifier 51 are connected to the output sides of the resistors R11 and R12. The bases of the transistors (Q51, Q52) to (Q51, Q52) of the differential amplifiers 52 to 54 are connected to the output terminals (T43, T44) to (T43, T44) of the attenuator circuits 42 to 44. A bias voltage V45 is applied to the center terminals T45 to T45 of the attenuator circuits 42 to 44.

The collectors of the transistors Q51 and Q51 of the differential amplifiers 51 and 52 are connected to the emitter of a base-grounded transistor Q55 to constitute a cascode amplifier 51B, and the collectors of the transistors Q52 and Q52 of the differential amplifiers 51 and 52 are connected to the emitter of a base-grounded transistor Q56 to constitute a cascode amplifier 52B. Similarly, cascode amplifiers 53B and 54B are formed for the differential amplifiers 53 and 54.

The collectors of the transistors Q55 and Q55 of the cascode amplifiers 51B and 53B are connected to a common load resistor R55, and the collectors of the transistors Q56 and Q56 of the cascode amplifiers 52B and 54B are connected to a common load resistor R56. Reception signals SRX obtained at the load resistors R55 and R56 are supplied to the next state mixer circuits 13A and 13B. Since the reception signals SRX are a balanced type, the mixer circuits 13A and 13B are each configured to be a balanced type.

The control current generating circuit 34 outputs four AGC control currents I51 to I54. These control currents I51 to I54 are supplied to the input side transistors Q54 to Q54 of the current mirror circuits 51A to 54A. A reference symbol T51 represents a power source terminal, This circuit is fabricated in the same one chip IC together with the receiver shown in FIG. 1.

With the circuit structure described above, as the reception signal SRX is outputted from the tuning circuit 11, the attenuator circuits 42 to 44 output reception signals SRX whose levels are lowered by 12 dB in succession.

It is assumed herein that of the control currents I51 to I54 outputted from the control current generating circuit 34, the control current I51 has a predetermined amplitude and the other control currents I52 to I54 are 0. In this case, the current I51 flows through the differential amplifier 51 via the current mirror circuit 51A so that the differential amplifier 51 is in operation, whereas the currents I52 to I54 will not flow through the other differential amplifiers 52 to 54 so that the differential amplifiers 52 to 54 are in non-operation.

The reception signals SRX outputted from the tuning circuit 11 are therefore supplied to the mixer circuits 13A and 13B via the differential amplifier 51 and cascode amplifiers 51B and 52B. In this case, since the differential amplifiers 52 to 54 are in non-operation, the reception signals SRX to be outputted from the attenuator circuits 42 to 44 will not be supplied to the mixer circuits 13A and 13B.

A gain A51 of the differential amplifier 51 is given by:
A51=a×I51 times (10),
where a is a constant.

Since the amplitude of the control current I51 changes with the AGC voltage VCTL, the gain A51 of the differential amplifier 51 changes correspondingly, controlling the level of the reception signals SRX to be supplied from the tuning circuit 11 to the mixer circuits 13A and 13B via the differential amplifier 51.

Similar to the gain A51, the other gains A52 to A54 of the differential amplifiers 52 to 54 are controlled by the control currents I52 to I54, and the reception signals SRX outputted from the attenuator circuits 42 to 44 are supplied via the differential amplifiers 52 to 54 to the mixer circuits 13A and 13B. Therefore, a change in the AGC voltage VCTL controls the levels of the reception signals SRX to SRX to be supplied from the attenuator circuits 42 to 44 to the mixer circuits 13A and 13B via the operational amplifiers 52 to 54.

Accordingly, AGC is conducted by changing the gain AV of the high frequency amplifier 12 in accordance with the AGC voltage VCTL.

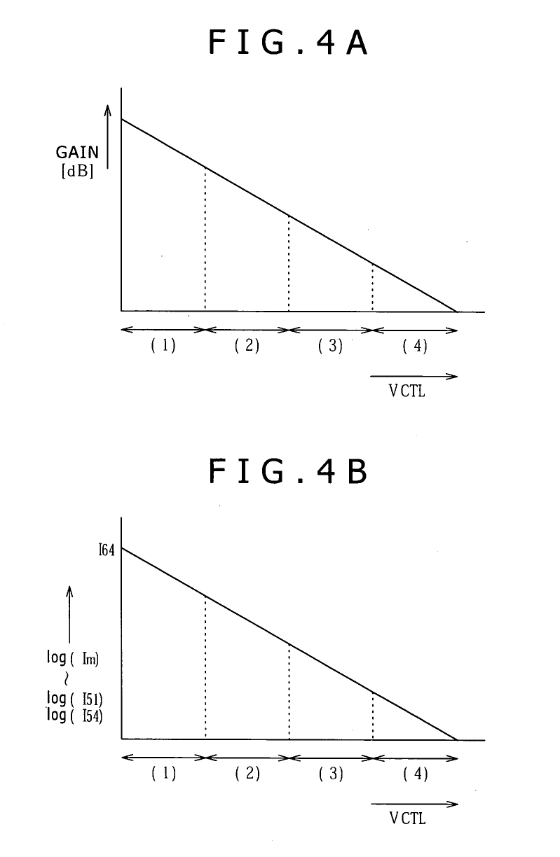

For example, as shown in the equation (10), the gains A51 to A54 of the differential amplifiers 51 to 54 change linearly with the control currents I51 to I54, respectively. Therefore, as shown in FIG. 4B, if the logarithmic values of the control currents I51 to I54 are changed linearly with the AGC voltage VCTL, the gains A51 to A54 of the differential amplifiers 51 to 54 change linearly with the logarithmic values of the control currents I51 to I54.

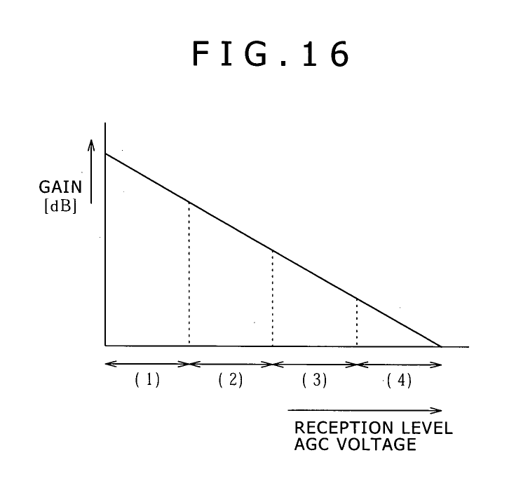

Therefore, for example, as shown in FIG. 4A (same as FIG. 16), the gain AV (decibel value) of the amplifier 12 can be changed linearly in a wide range: by picking up the reception signals SRX from the differential amplifier 51 and controlling the gain A51 by the control current I51 when the AGC voltage VCTL is in the range (1), by picking up the reception signals SRX from the differential amplifier 52 and controlling the gain A52 by the control current I52 when the AGC voltage VCTL is in the range (2), and etc.

[3] Control Current Forming Circuit 34

The control current generating circuit 34 generates the control current I51 to 154 in accordance with the AGC voltage VCTL (VAGC, VOL) as described above, also switches between the differential amplifiers 51 to 54 and performs logarithmic compression of the control currents I51 to I54.

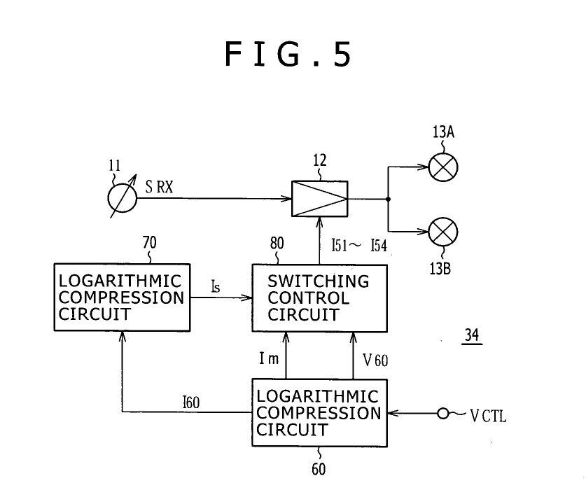

To this end, the control current generating circuit 34 is constituted of, for example, as shown in FIG. 5, logarithmic compression circuits 60 and 70 and a switching control circuit 80. For example, the logarithmic compression circuits 60 and 70 and the switching control circuit 80 have the following structures.

[3-1] Logarithmic Compression Circuit 60

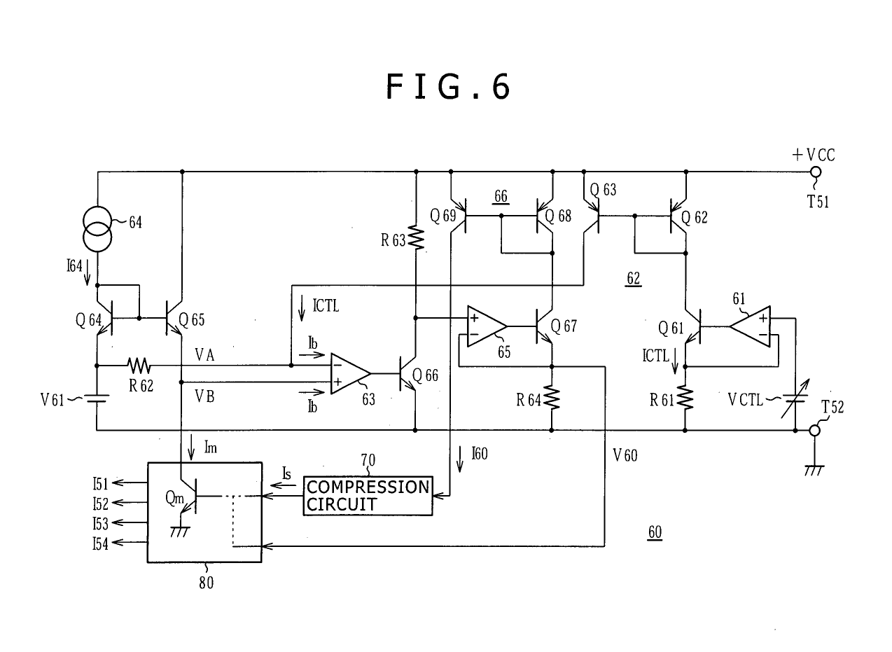

FIG. 6 shows an example of the logarithmic compression circuit 60. The logarithmic compression circuit 60 logarithmically converts the AGC voltage VCTL into a control current Im. Although it will become clear from the later description, Im=151 within the range (1) shown in FIG. 4A, Im=152 within the range (2), Im=153 within the range (3), and Im=154 within the range (4). Namely, within the ranges (1) to (4), the control current Im is the control currents I51 to I54, respectively.

Referring to FIG. 6, the AGC voltage VCTL is applied to a non-inverting input terminal of an operational amplifier 61, its output terminal is connected to the base of a transistor Q61, and a resistor R61 is connected to the emitter and the ground terminal T52. A voltage across the resistor R61 is applied to an inverting terminal of the operational amplifier 61.

The collector of the transistor Q61 is connected to the collector of a transistor Q62. This transistor Q62 and a transistor Q63 constitute a current mirror circuit 62 by using a reference potential point at the power source terminal T51. The collector of the transistor Q63 is connected to a non-inverting input terminal of a voltage comparison operational amplifier 63, and to a voltage source of a bias voltage V61 via a resistor R62.

The bases of transistors Q64 and Q65 are interconnected and connected to the collector of the transistor Q64, and a constant current source 64 is connected between the collector and the power source terminal T51. The emitter of the transistor Q64 is connected to the voltage source of the bias voltage V61, the emitter of the transistor Q65 is connected to an inverting input terminal of the operational amplifier 63 and the collector is connected to the power source terminal T51.

An output terminal of the operational amplifier 63 is connected to the base of a transistor Q66 whose emitter is grounded, and the collector of the transistor Q66 is connected to a non-inverting terminal of an operational amplifier 65 whose output terminal is connected to the base of a transistor Q67. A resistor R64 is connected between the emitter of the transistor Q67 and the ground terminal T52, and the emitter of the transistor Q67 is connected to an inverting terminal of the operational amplifier 65.

A voltage V60 across the resistor R64 is supplied to the switching control circuit 80. The collector of a transistor Q67 is connected to an input side transistor Q68 constituting a current mirror circuit 66, and a current I60 is picked up from an output side transistor Q69. This current I60 is converted by the logarithmic compression circuit 70 into a predetermined control current Is as will be later described, and the control current Is is supplied to the switching control circuit 80.

Although the details of the switching control circuit 80 will be later described, a transistor Qm is equivalent to an output transistor of the switching control circuit 80 and its collector is connected to the non-inverting terminal of the operational amplifier 63. A collector current of the transistor Qm is the control current Im. A voltage V60 and control current Is are supplied to the transistor Qm at polarities realizing negative feedback.

With the structure described above, 100% negative feedback is applied to the operational amplifier 65 via the transistor Q67, and the operational amplifier 65 and transistor Q67 operate as a voltage follower. Therefore, an output of the operational amplifier is negative-fed back to the transistor Qm via the transistor Q66 and via the operational amplifier 65 and transistor Q67.

Since negative feedback is given to the operational amplifier 63, the following equation is satisfied:
VB=VA (11),
where VA is a potential at the inverting input terminal of the operational amplifier 63 and VB is a potential at the non-inverting terminal of the operational amplifier 63.

The following equations are also satisfied:
VA=V61+VR62 (12)
V61+VBE64=VB+VBE65 (13),
where VR62 is a voltage across the resistor R62, VBE64 is a base-emitter voltage of the transistor Q64, and VBE65 is a base-emitter voltage of the transistor Q65.

From the equations (11) to (13), the following equation is derived:
VBE64−VBE65=VR62 (14)

The following equations are also met:
I64=α×exp(β×VBE64) (15)
IC65=α×exp(β×VBE65) (16),
where α is a constant, β=q/(K×T) where q is an electron charge, K is the Boltzmann's constant and T is an absolute temperature, I64 is an output current of the constant current source 64 which is the collector (emitter) current of the transistor Q64, and IC65 is a collector (emitter) current of the transistor Q65.

From the equations (15) and (16), the following equation is derived:
I64/IC65=exp(β×(VBE64−VBE65))

By substituting the equation (14) in this equation, the following equation can be obtained:
I64/IC65=exp(β×VR62) (17)

Logarithm of the equation (17) becomes:
log(I64)−log(IC65)=β×VR62

By rearranging this equation, it becomes:
log(IC65)=−βVR62+log(I64) (18)

Since 100% negative feed back is given to the operational amplifier 61 via the transistor Q61, a voltage across the resistor R61 is VCTL:
ICTL=VCTL/R61,
where ICTL is a current flowing through the resistor F61.

Since this ICTL is a collector current of the transistor Q61 and flows through the resistor R62 via the current mirror circuit 62:
VR62=ICTL×R62=R62/R61×VCTL (19)

By substituting the equation (19) in the equation (18), the following equation is obtained:
log(IC65)=γ×VCTL+log (I64) (20),
where γ=β×R62/R61.

Since Im=IC65, the equation (20) becomes:
log(Im)=−γ×VCTL+log(I64) (21)

If VCTL=0, the equation (21) becomes:
log(Im)=log(I64) (22)

This means that the control current Im is equal to the output current I64 of the constant current source 64.

Therefore, the relation between the AGC voltage VCTL and the control current Im becomes as shown in FIG. 4B, and the logarithmic value log (Im) of the control current Im becomes linearly proportional to the AGC voltage VCTL with a negative coefficient −γ. Namely, the AGC voltage VCTL is converted into a logarithmically compressed control current Im.

[3-2] Logarithmic Compression Circuit 70

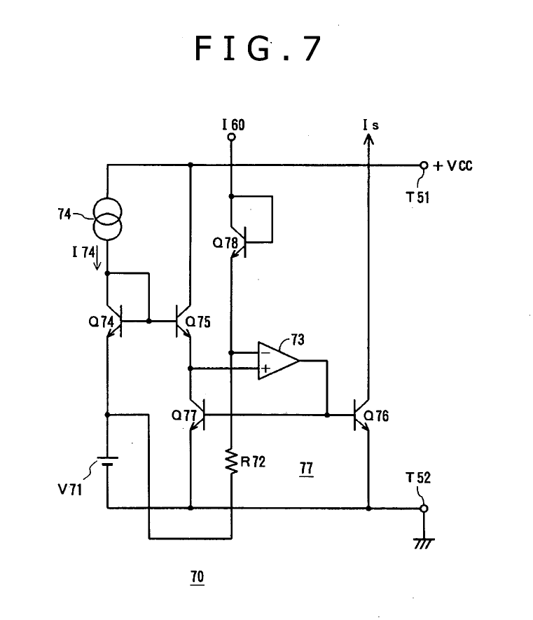

FIG. 7 shows an example of the logarithmic compression circuit 70. The logarithmic compression circuit 60 converts the current I60 outputted from the logarithmic compression circuit 60, which current is linearly proportional to the AGC voltage VCTL, into a control current Is linearly proportional to log (I60). The logarithmic compression circuit 70 is structured basically similar to the logarithmic compression circuit 60.

Referring to FIG. 7, the current I60 from the logarithmic compression circuit 60 is applied to one end of a resistor R72 via a diode-connected transistor Q78, and the resistor R72 is connected to a voltage source of a bias voltage V71. A voltage across the resistor R72 is applied to an inverting terminal of a voltage comparison operational amplifier 73.

The bases of transistors Q74 and Q75 are interconnected and connected to the collector of the transistor Q74. Between the collector and the power source terminal T51, a constant current source 74 is connected. The emitter of the transistor Q74 is connected to the voltage source of the bias voltage V71, the emitter of the transistor Q75 is connected to a non-inverting terminal of the operational amplifier 73, and the collector of the transistor Q75 is connected to the power source terminal T51.

An output terminal of the operational amplifier 73 is connected to the base of a transistor Q77, the collector is connected to a non-inverting terminal of the operational amplifier 73, and the emitter is connected to the ground terminal T52. In parallel to the base-emitter path of the transistor Q77, the base-emitter path of a transistor Q76 is connected. A collector current of the transistor Q76 is picked up as the control current Is which is supplied to the switching control circuit 80.

With the structure described above, the interconnection relation among the operational amplifier 73, transistors Q74 and Q75 and resistor R72 is equal to the interconnection relation among the operational amplifier 63, transistors Q64 and Q65 and resistor R62 of the logarithmic compression circuit 60 shown in FIG. 6. As the current I60 flows through the resistor R72, the voltage across the resistor 73 is applied to the inverting terminal of the operational amplifier 73. In the operational amplifier 73, an output is negative-fed back to the non-inverting terminal via the transistor Q77.

Since the current IC75 corresponds to the control current Im shown in FIG. 6, the following equation is derived from the equation (18):
log(IC75)=−β×VR72+log(I74) (31),
where VR72 is a voltage across the resistor R72, I74 is an output current of the constant current source 74 and is equal to a collector (emitter) current of the transistor Q74, and IC75 is a collector (emitter) current of the transistor Q75.

In this case, since VR72=R62×I60, this is substituted in the equation (31) to derive:
log(IC75)=−β×R62×I60+log(I74) (32)

The collector current I75 of the transistor Q75 is equal to the collector current IC77 of the transistor Q77. Since the same base bias voltage is applied to the transistors Q77 and Q76 from the collector of the transistor Q77 via the operational amplifier 73, the transistors Q77 and Q66 operate as a current mirror circuit 77 using the transistor Q77 as an input side, and the collector current IC76 of the transistor Q76 is equal to the collector current Is of the transistor Q77. Namely:
IC75=IC77=Is

The equation (32) therefore becomes:
log(Is)=−β×R62×I60+log(I74) (33),
so that the logarithmic value log (Is) of the control current Is is linearly proportional to the current I60. The control current Is having these characteristics is supplied to the switching control circuit 80.

[3-3] Switching Control Circuit 80

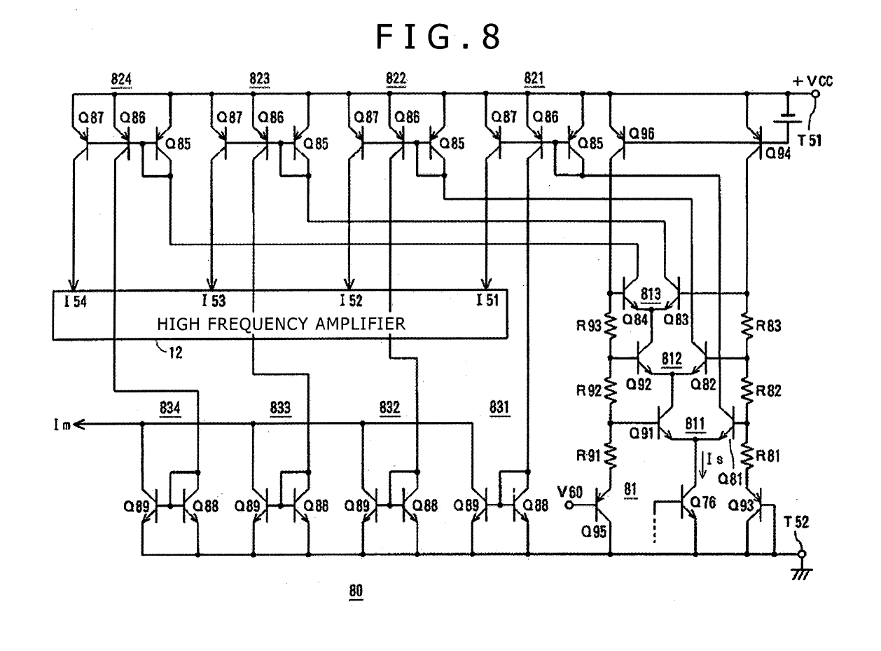

FIG. 8 shows an example of the switching control circuit 80. This control circuit 80 generates the control currents I51 to I54 and Im from the output voltage V60 of the logarithmic compression circuit 60 and the output current Is of the logarithmic compression circuit 70.

The switching control circuit 80 shown in FIG. 8 is constituted of a voltage comparison circuit 81 and current mirror circuits 821 to 824 and 831 to 834. The voltage comparison circuit 81 compares the voltage V60 with a reference voltage to thereby switch the differential amplifiers 51 to 54 in accordance with voltages corresponding to the ranges (1) to (4) shown in FIG. 4B.

Namely, the emitter-collector path of a constant current source transistor Q94, resistors R83 to R81 and the emitter-collector path of a transistor Q93 are serially connected between the power source terminal T51 and ground terminal T52. A predetermined bias voltage is applied to the base of the transistor Q94, and the base of the transistor Q93 is connected to the ground terminal T52. Reference voltages corresponding to the ranges (1) to (4) shown in FIG. 4B are derived at the interconnection points of the resistors R81 to R83.

The emitter-collector path of a constant current source transistor Q96, resistors R93 to R91 and the emitter-collector path of a transistor Q95 are serially connected between the power source terminal T51 and ground terminal T52. A predetermined bias voltage is applied to the base of the transistor Q96, and the voltage V60 from the logarithmic compression circuit 60 is applied to the base of the transistor Q95.

By using the transistor Q76 of the logarithmic compression circuit 70 shown in FIG. 7 as a constant current source, transistors Q91 and Q81 are differentially connected to constitute a voltage comparison circuit 811. The base of the transistor Q91 is connected to the interconnection point between the resistors R92 and R91, and the base of the transistor Q81 is connected to the interconnection point between the resistors R82 and R81.

By using the transistor Q91 as a constant current source, the transistors Q92 and Q82 are differentially connected to constitute a voltage comparison circuit 812. The base of the transistor Q92 is connected to the interconnection point between the resistors R93 and R92, and the base of the transistor Q82 is connected to the interconnection point between the resistors R83 and R82.

By using the transistor Q92 as a constant current source, the transistors Q84 and Q83 are differentially connected to constitute a voltage comparison circuit 813. The base of the transistor Q84 is connected to the collector of the transistor Q86, and the base of the transistor Q83 is connected to the collector of the transistor Q84.

A current mirror circuit 821 using the reference potential point at the power source terminal T51 is constituted of transistors Q85 to Q87. The collector of the input side transistor Q85 is connected to the collector of the transistor Q81. Similarly, current mirror circuits 822 to 824 are constituted of transistors (Q85 to Q87) to (Q85 to Q87), and the collectors of the input side transistors Q85 to Q85 are connected to the collectors of the transistors Q82, Q83 and Q84.

A current mirror circuit 831 using the reference potential point at the ground terminal T52 is constituted of transistors Q88 and Q89, and the collector of the input side transistor Q88 is connected to the first output side transistor Q86 of the current mirror circuit 821. Similarly, current mirror circuits 832 to 834 are constituted of transistors (Q88 and Q89) to (Q88 and Q89), and the collectors of the input side transistors Q88 to Q88 are connected to the collectors of the first output side transistors Q86 to Q86 of the current mirror circuits 822 to 824.

The collectors of the second output side transistors Q87 to Q87 of the current mirror circuits 821 to 824 are connected to the collectors of the input side transistors Q54 to Q54 of the current mirror circuits 51A to 54A shown in FIG. 2. Therefore, the collector currents of the second output side transistors Q87 to Q87 of the current mirror circuits 821 to 824 are equal to the collector currents I51 to I54 of the input side transistors Q54 to Q54 of the current mirror circuits 51A to 54A of the high frequency amplifier 12.

The output side transistors Q89 to Q89 of the current mirror circuits 831 to 834 correspond to the transistor Qm of the switching control circuit 80 shown in FIG. 6. The collectors of the transistors Q89 to Q89 are interconnected and connected to the emitter of the transistor Q65 of the logarithmic compression circuit 60.

The collector current of each of the input side transistors Q85 to Q85 of the current mirror circuits 821 to 824 is set to have a predetermined ratio relative to the collector current of each of the output side transistors (Q86 and Q87) to (Q86 and Q87). Collector currents of the transistors (Q86 and Q87) to (Q86 to Q87) of the current mirror circuits 821 to 824 are set to have ratios of 1/1:1/4:1/16:1/64. This ratio is determined in correspondence with the attenuation amount of 12 dB (=¼) of each of the attenuator circuits 42 to 44.

With the structure described above, as the AGC voltage VCTL becomes larger, the control voltage V60 becomes larger and the collector current of the transistor Q85 becomes smaller. Therefore, as the AGC voltage VCTL becomes larger, the base voltages of the transistors Q91, Q92 and Q84 become larger so that by setting properly the values of the resistors R81 to R83 and R91 to R93, the transistors Q81 to Q84, Q91 and Q92 can be turned on and off in the following manner:
(A) if the AGC voltage VCTL has an amplitude within the range (1) shown in FIG. 4, then
the transistor Q91 is off and the transistor Q81 is on (since the transistor Q91 is off, the transistors Q92 and Q82 to Q84 are also off);
(B) if the AGC voltage VCTL has an amplitude within the range (2) shown in FIG. 4, then
the transistor Q91 is on and the transistor Q81 is off, and
the transistor Q92 is off and the transistor Q82 is on (since the transistor Q92 is off, the transistors Q83 and Q84 are also off);
(C) if the AGC voltage VCTL has an amplitude within the range (3) shown in FIG. 4, then
the transistor Q91 is on and the transistor Q81 is off,
the transistor Q92 is on and the transistor Q82 is off, and
the transistor Q84 is off and the transistor Q83 is on; and
(D) if the AGC voltage VCTL has an amplitude within the range (4) shown in FIG. 4, then
the transistor Q91 is on and the transistor Q81 is off,
the transistor Q92 is on and the transistor Q82 is off, and
the transistor Q84 is on and the transistor Q83 is off.

In the case of (A), the output current Is of the transistor Q76 flows as the control current I51 (=Is) flowing through the amplifier 12 via the transistor Q81 and the current mirror circuit 821, and as the control current Im (=I51) flowing through the logarithmic compression circuit 60 via the current mirror circuit 831. In this case, the transistors Q91, Q81, Q82 to Q84 are off and I52 to I54 are 0.

Accordingly, in the circuit shown in FIG. 2, the reception signal SRX outputted from the tuning circuit 11 is supplied to the mixer circuits 13A and 13B via the differential amplifier 51. In this case, as shown in FIG. 4B, since the control current I51 (=Im) changes in a logarithmic function manner in accordance with the AGC voltage VCTL, the gain A51 of the differential amplifier 51 changes in the logarithmic function manner in accordance with the AGC voltage VCTL so that the characteristics within the range (1) shown in FIG. 4A can be obtained.

In the case of (B), the output current Is of the transistor Q76 flows as the control current I52 (=Is) flowing through the amplifier 12 via the transistors Q91 and Q82 and the current mirror circuit 822, and as the control current Im (=I52) flowing through the logarithmic compression circuit 60 via the current mirror circuit 832. In this case, the transistors Q81, Q92, Q83 and Q84 are off and I51, I53 and I54 are 0.

Accordingly, in the circuit shown in FIG. 2, the reception signal SRX outputted from the attenuator circuit 42 is supplied to the mixer circuits 13A and 13B via the differential amplifier 52. In this case, as shown in FIG. 4B, since the control current I52 (=Im) changes in the logarithmic function manner in accordance with the AGC voltage VCTL, the gain A of the differential amplifier 52 changes in the logarithmic function manner in accordance with the AGC voltage VCTL so that the characteristics within the range (2) shown in FIG. 4A can be obtained.

Similar operations are performed also for the cases (C) and (D) and the output current Is of the transistor Q76 flows as the control current I53 or I54 flowing through the amplifier 12 so that the characteristics within the range (3) or (4) shown in FIG. 4A can be obtained.

The characteristics shown in FIG. 4A between the AGC voltage VCTL and the gain (decibel value) can therefore be obtained.

Since the control currents I51 to I54 are changed to the control current Im via the current mirror circuits 821 to 824 and the current mirror circuits 831 to 834 and this control current Im is negative-fed back to the operational amplifier 63 shown in FIG. 6, the characteristics at the boundaries of the ranges (1) to (4) shown in FIG. 4A can be changed linearly, resulting in a linear change in the gain (decibel value) over the whole broad range.

Since the characteristics can be changed linearly over the broad range, the AGC operation having constant response characteristics can be obtained in a broad input range from a weak reception signal to a large reception signal.

[4] Compensation for Bias Current and Temperature Characteristics

Description will be made on compensation for bias currents and temperature characteristics of the logarithmic compression circuits 60 and 70.

[4-1] Logarithmic Compression Circuit 60

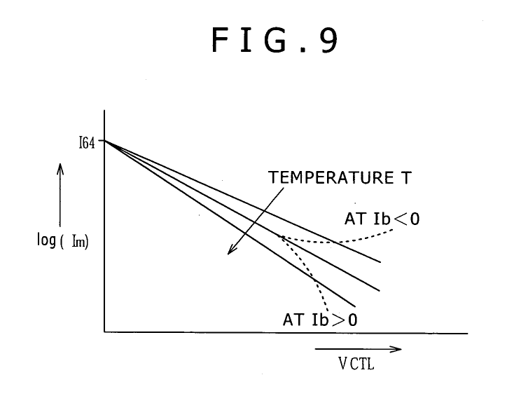

In the logarithmic compression circuit 60 shown in FIG. 6, the bias currents Ib and Ib of the transistors constituting the operational amplifier 63 flow through the inverting input terminal and non-inverting input terminal of the operational amplifier 63. As the AGC voltage VCTL (control voltage V60) becomes large, the collector current IC65 (=Im) of the transistor Q65 becomes small. In this case, the current Ib flowing through the non-inverting input terminal of the operational amplifier 63 becomes not negligible and the logarithmic compression characteristics of the control current Im shift from the linear characteristics as indicated by a broken line in FIG. 9. Therefore, the range becomes narrow in which the decibel value of the gain can be controlled linearly.

In order to solve this problem, the amplitude of the collector current IC65 is set so that the collector current maintains sufficiently larger than the base current Ib even if the collector current IC65 (=Im) becomes smaller. However, the consumption current of the logarithmic compression circuit increases.

Furthermore, in the logarithmic compression circuit shown in FIG. 6, as apparent from the equations (16) and (20), since the equation having a term −γ representative of the slope of the compression characteristics contains the absolute temperature T, the compression characteristics change with the absolute temperature T as shown in FIG. 9.

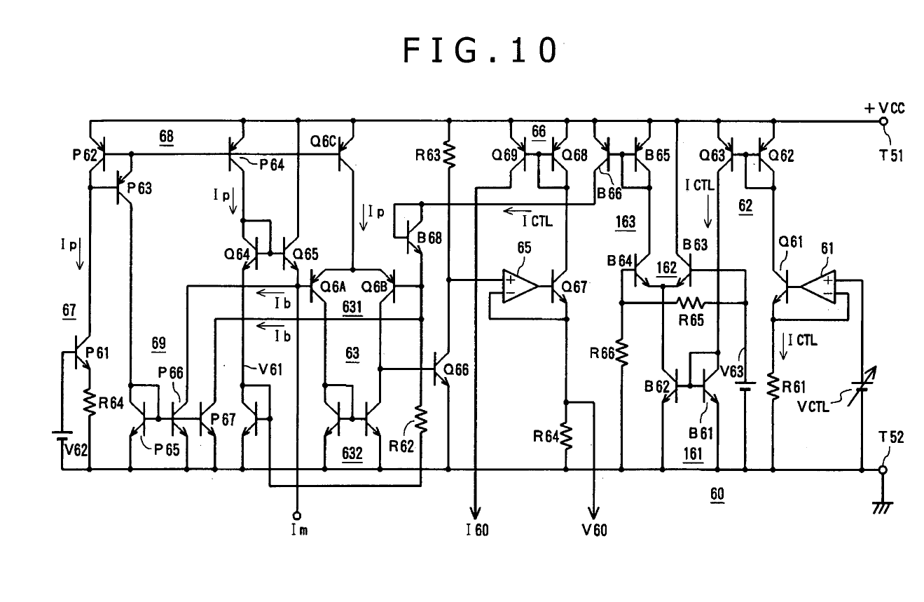

A logarithmic compression circuit 60 shown in FIG. 10 can neglect the bias currents Ib and Ib flowing through an operational amplifier 63 and can compensate for the temperature characteristics.

A compensation circuit for the bias currents Ib and Ib is structured in the following manner. In an operational amplifier 63, the emitters of transistors Q6A and Q6B are connected to the collector of a constant current source transistor Q6C to constitute a differential amplifier 631. As a load of the differential amplifier 631, a current mirror circuit 632 is connected to the collectors of the transistors Q6A and Q6B. The operational amplifier 63 is therefore formed having the base of the transistor Q6A as a non-inverting input terminal, the base of the transistor Q6B as an inverting input terminal and the collector of the transistor Q6B as an output terminal.

A transistor P61 is provided in which a bias voltage V62 is applied to the base and a resistor R64 is connected between the emitter and a ground terminal T52, to thereby constitute a constant current source 67. A constant current Ip is supplied from the collector of the transistor P61. In this case, the bias voltage V62 is a band gap voltage across a serial circuit constituted of a predetermined number of diode-connected transistors with the base and emitter connected together, a DC voltage being applied via a resistor to the serial circuit.

The constant current Ip flows through a transistor P62 which constitutes a current mirror circuit 68 together with transistors P64 and Q6C, the current mirror circuit being biased with a transistor P63. The transistor P64 constitutes the constant current source 64 shown in FIG. 6 so that the collector current of the transistor P64 corresponds to the constant current I64 shown in FIG. 6 and I64=Ip. The collector current of the transistor P63 has also the value Ip.

The collector current of the transistor P63 flows through a transistor P65 which constitutes a current mirror circuit 69 together with transistors P66 and P67. The collectors of the transistors P66 and P67 are connected to the bases of the transistors Q6A and Q6B. The collector currents of the transistors P66 and P67 are therefore supplied to the bases of the transistors Q6A and Q6B as bias currents Ib and IB.

The collector current of the transistor P63 is given by:
3×Ip/hFE,
where hFE is a current amplification factor of the transistors P62, P63, and Q6A to Q6C. The transistors Q6A and Q6B satisfy the following equation:
Ib=Ip/(2×hFE)

Therefore, for example, if the junction area of the base-emitter of the transistors P66 and P67 are set to ⅙ of the junction area of the transistor P65, then the collector current of the transistors P66, P67 is:
Ip/(2×hFE)

Therefore, the bias currents Ib and Ib flowing through the operational amplifier 63 (bases of the transistors Q6A and Q6B) are cancelled out by the collector currents of the transistors P66 and P67 so that the linear compression characteristics indicated by solid lines in FIG. 9 can be obtained.

A temperature compensation circuit for the compression characteristics is structured in the following manner. The collector of an output side transistor Q63 constituting a current mirror circuit 62 is connected to the collector of an input side transistor B61 of a current mirror circuit 161, and an output side transistor B62 as a constant current source and transistors B63 and B64 constitute a differential amplifier 162.

In the differential amplifier 162, a predetermined base bias voltage V63 is applied to the base of the transistor B63, and the bias voltage V63 divided by resistors R65 and R66 is applied to the base of the transistor B64. Similar to the bias voltage V62, the bias voltage V63 is a band gap voltage.

As a current ICTL flows through the collector of the transistor Q63, this current ICTL flows through the differential amplifier 162 via the current mirror circuit 161. In this case, the current ICTL divisionally flows through the transistors B63 and B64 at the dividing ratio between the resistors R65 and R66.

The current ICTL divisionally flowing through the transistor B64 flows through a resistor R62 via a current mirror circuit 163 constituted of transistors B65 and B66 and via a diode-connected transistor B68.

Although the current ICTL proportional to the AGC voltage VCTL flows through the resistor R62, the current ICTL flowing through the resistor R62 is a current divided by the differential amplifier 162 and having an amplitude determined by the resistors R65 and R66 and the band gap voltage V63. Therefore, the current ICTL flowing through the resistor R62 is a current having a positive temperature coefficient.

A voltage VR62 across the resistor R62 has therefore a positive temperature coefficient. By properly setting the resistors R65 and R66 and the band gap voltage V63, a temperature change in the compression characteristics shown in FIG. 9 can be cancelled out by the temperature characteristics of the current ICTL so that the temperature change in the compression characteristics can be suppressed.

It is also possible to suppress a temperature change in the gain AV of the high frequency amplifier 12 subjected to gain control. More specifically, the gain A51 of the differential amplifier 51 shown in FIG. 2 is given by the equation (10):
A51=a×I51 times (10),
where a is a constant and equal to (½)×β×RL, RL being a load resistor.
Therefore:
A51=β×RL×I5×½ (41)

Within the range (1) shown in FIG. 4A, because of the current mirror circuit 821:
I51=IM,
so that the equation (41) becomes:
A51=β×RL×Im/2 (42)

If the load resistor RL is formed in an IC, the load resistor RL changes with a temperature and the transistor has temperature characteristics so that the gain A51 is influenced by the temperature.

However, the voltage V62 shown in FIG. 10 is a band gap voltage:
V62=VBE61+N/β,
where VBE61 is a base-emitter voltage of the transistor P61 and N is a constant. The constant N can be set in such a manner that the temperature characteristics of the band gap voltage V62 can be neglected.

The constant current Ip supplied from the transistor P61 is therefore given by:

$$\begin{matrix}Ip = ( V62 - VBE61 ) / R64 \\ = ( N / ß ) / R64\end{matrix} \qquad ( 43 )$$

As shown in FIG. 4B and the equation (22), the gain A51 of the differential amplifier 51 shown in FIG. 2 takes a maximum value at VCTL=0. For the purposes of simplicity, assuming that VCTL=0, the equation (22) becomes:
Im=I64 (44)

In FIG. 10, the collector current I64 of the transistor Q64 is equal to the current Ip. Therefore, the equation (44) is rearranged by the equation (43):

$$\begin{matrix}Im = Ip \\ = ( N / ß ) / R64\end{matrix} \qquad ( 45 )$$

Substituting the equation (45) in the equation (42) results in:

$$\begin{matrix}A51 = ß \times RL \times Im / 2 \\ = ß \times RL \times ( ( N / ß ) / R64 ) / 2 \\ = ( N / 2 ) \times RL / R64\end{matrix} \qquad ( 46 )$$

The gain A51 of the differential amplifier 51 is determined by the constant independent from the temperature and a resistor ratio RL/R64, the resistor ratio RL/R64 being not influenced by the temperature. As described above, the conversion characteristics of the control voltage VCTL and control current ICTL are not influenced by the temperature. The differential amplifiers 52 to 54 are neither influenced by the temperature.

Accordingly, with the logarithmic compression circuit 60 shown in FIG. 10, the gain AV of the high frequency amplifier 12 can be controlled to make the decibel value linear, and the gain AV will not be influenced by the temperature. Since a variation of resistor ratios RL/R64 in IC fabrication is small, a variation of ICs can be suppressed.

[4-2] Logarithmic Compression Circuit 70

Similar to the operational amplifier 63 of the logarithmic compression circuit 60 shown in FIG. 6, bias currents of the transistors constituting the operational amplifier 73 of the logarithmic compression circuit 70 shown in FIG. 7 flow through the inverting input terminal and non-inverting input terminal of the operational amplifier 73. As collector current of the transistor Q77 becomes small, i.e., as the current Is becomes small, the bias current flowing through the non-inverting input terminal of the operational amplifier 73 becomes not negligible.

Since the relation between the currents Is and 160 is represented by the equation (33), similar to the logarithmic compression circuit 60 shown in FIG. 6, the logarithmic compression circuit 70 is influenced by the temperature T.

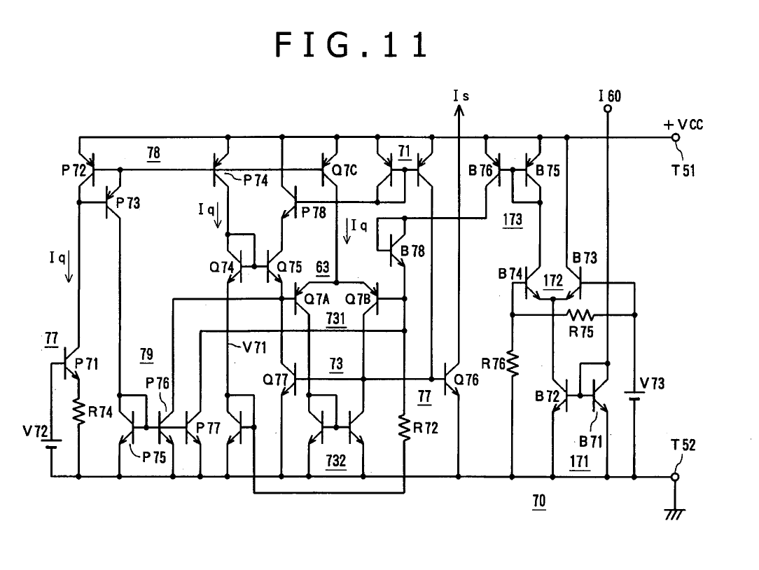

A logarithmic compression circuit 60 shown in FIG. 11 can neglect the bias currents flowing through an operational amplifier 73 and can compensate for the temperature characteristics.

A compensation circuit for the bias currents and temperature characteristics is structured in the manner similar to the logarithmic compression circuit 60 shown in FIG. 10. The compensation circuit for the bias current is structured in the following manner. In the operational amplifier 73, the emitters of transistors Q7A and Q7B are connected to the collector of a constant current source transistor Q7C to constitute a differential amplifier 731. As a load of the differential amplifier 731, a current mirror circuit 732 is connected to the collectors of the transistors Q7A and Q7B. The operational amplifier 73 is therefore formed having the base of the transistor Q7A as a non-inverting input terminal, the base of the transistor Q7B as an inverting input terminal and the collector of the transistor Q7B as an output terminal.

A transistor P71 is provided in which a bias voltage V72 is applied to the base and a resistor R74 is connected between the emitter and a ground terminal T52, to thereby constitute a constant current source 77. A constant current Iq is supplied from the collector of the transistor P71. In this case, similar to the bias voltage V62, the bias voltage V72 is a band gap voltage. It is possible to set Iq=Ip.

The current Iq flows through a transistor P72 which constitutes a current mirror circuit 68 together with transistors P74 and Q7C, the current mirror circuit being biased with a transistor P73. The transistor P74 constitutes the constant current source 74 shown in FIG. 7 so that the collector current of the transistor P74 corresponds to the constant current I74 shown in FIGS. 7 and 174=Iq. The collector current of the transistor P73 has also the value Iq.

The collector current of the transistor P73 flows through a transistor P75 which constitutes a current mirror circuit 79 together with transistors P76 and P77. The collectors of the transistors P76 and P77 are connected to the bases of the transistors Q7A and Q7B.

The collector currents of the transistors P76 and P77 are therefore supplied to the bases of the transistors Q7A and Q7B as bias currents. Therefore, similar to the operational amplifier 63 of the logarithmic compression circuit 60, it is possible to cancel out the bias currents flowing through the operational amplifier 73 (bases of the transistors Q7A and Q7B).

A temperature compensation circuit is structured in the following manner. An output current I60 of the logarithmic compression circuit 60 flows through an input side transistor B71 of a current mirror circuit 171, and an output side transistor B72 as a constant current source and transistors B73 and B74 constitute a differential amplifier 172.

In the differential amplifier 172, a predetermined base bias voltage V73 is applied to the base of the transistor B73, and the bias voltage V73 divided by resistors R75 and R76 is applied to the base of the transistor B74. Similar to the bias voltage V62, the bias voltage V73 is a band gap voltage.

As the current I60 is supplied from the logarithmic compression circuit 60, this current I60 divisionally flows through transistors B73 and B74 via a current mirror circuit 171. The current I60 divisionally flowing through the transistors B74 flows through a resistor R72 via a current mirror circuit 173 constituted of resistors B75 and B76 and via a diode-connected transistor B78.

A voltage across the resistor R72 can be made to be proportional to the current I60 and have a positive temperature coefficient. It is therefore possible to compensate for the temperature characteristics between the currents 160 and Is.

[4-3] Supplement

The structure of the switching control circuit 80 described in [3-3] can be used for the logarithmic compression circuits 60 and 70 having the structures described in [4-1] and [4-2].

[5] Two Independent AGC Systems

For AGC of the high frequency amplifier 12, as described earlier, AGC by the AGC voltage VOL is the delayed AGC effective for mainly large interference signals, and AGC by the AGC voltage VAGC is the AGC effective mainly for a desired reception signal. In the following, description will be made on independent AGCs by the AGC voltages VAGC and VOL.

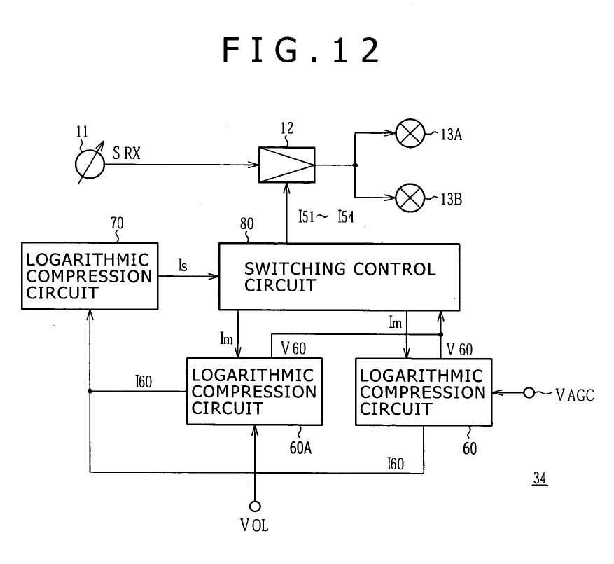

As shown in FIG. 12, in addition to a logarithmic compression circuit 60, another logarithmic compression circuit 60A is prepared. The logarithmic compression circuit 60 generates a voltage V60 and a current I60 from the AGC voltage VAGC, and the logarithmic compression circuit 60A generates a voltage V60 and a current I60 from the delayed AGC voltage VOL. These voltages V60 and V60 are supplied to a switching control circuit 80.

The currents I60 and I60 are supplied from the logarithmic compression circuits 60 and 60A to the logarithmic compression circuit 70 which outputs a control current Is. The control current Is is supplied to the switching control circuit 80 which generates control currents I51 to I54. The control currents I51 to I54 are supplied to the high frequency amplifier 12. Control currents Im and Im supplied from the logarithmic compression circuit 70 are negative-fed back to the logarithmic compression circuits 60 and 60A.

[5-1] Logarithmic Compression Circuit 60

The logarithmic compression circuit 60 shown in FIG. 12 is structured, for example, as shown in FIG. 10, and the AGC voltage AGC is used in place of the AGC voltage VCTL shown in FIG. 10. The voltage V60 and current I60 are generated and the control current Im is negative-fed back.

[5-2] Logarithmic Compression Circuit 60A

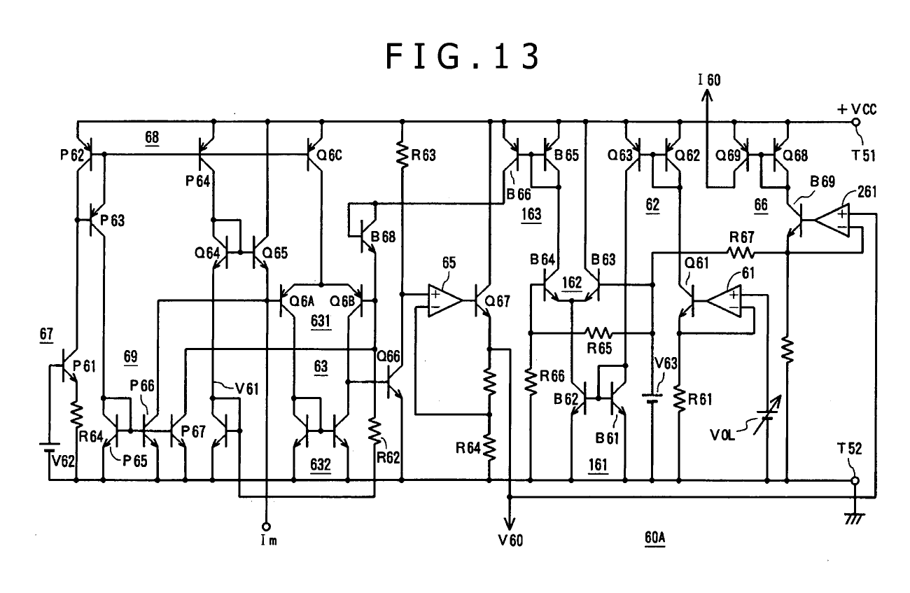

The logarithmic compression circuit 60A is structured, for example, as shown in FIG. 13 having the same structure as that of the logarithmic compression circuit 60 shown in FIG. 10. Corresponding elements are represented by identical reference symbols and the description thereof is omitted.

In this logarithmic compression circuit 60A, a voltage V60 is outputted from the emitter of a transistor Q67 and applied to a transistor B63 of a differential amplifier 162 via an operational amplifier 261 and a transistor B69 constituting a voltage follower and via a resistor R67. The collector current of the transistor B69 is picked up as a current I60 via a current mirror circuit 66.

The collector of a transistor Q69 of the current mirror circuit 66 and the collector of the transistor Q69 of the current mirror circuit 66 of the logarithmic compression circuit 60 shown in FIG. 10 are wired-OR connected and connected to the transistor B71 of the current mirror circuit 171 of the logarithmic compression circuit 70 shown in FIG. 11.

[5-3] Logarithmic Compression Circuit 70

The logarithmic compression circuit 70 shown in FIG. 12 may be structured as shown in FIG. 11.

[5-4] Switching Control Circuit 80

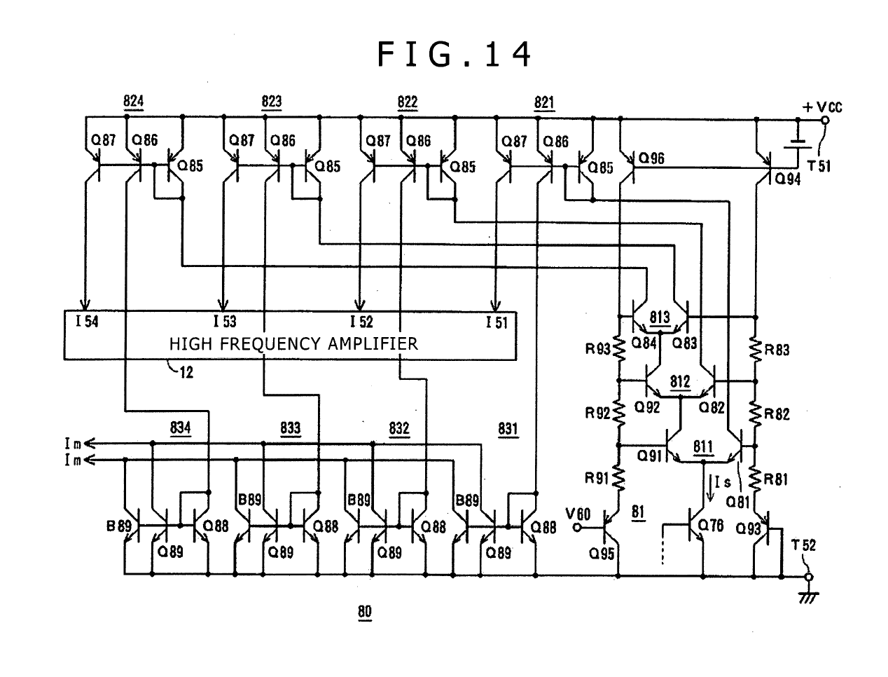

The switching control circuit 80 shown in FIG. 12 is structured fundamentally in the manner similar to the switching control circuit 80 shown in FIG. 8. In order to prevent interference between the logarithmic compression circuit 60 and logarithmic compression circuit 60A, the switching control circuit 80 is structured, for example, as shown in FIG. 14.

In FIG. 14, corresponding elements to those in the switching control circuit 80 shown in FIG. 8 are represented by identical reference symbols and the description thereof is omitted. Current mirror circuits 831 to 834 have additional output side transistors B89 to B89 whose collectors are connected together.

The common collector of the transistors B89 to B89 is connected to the base of the transistor Q6A of the differential amplifier 631 of the logarithmic compression circuit 60A shown in FIG. 13, and to the base of the transistor Q6A of the operational amplifier 631 of the logarithmic compression circuit 60 shown in FIG. 10.

The control currents Im and Im can therefore be negative-fed back to the logarithmic compression circuits 60 and 60A.

[5-5] Supplement

The AGC voltage VOL is a signal representative of an amplitude of mainly a large level interference signal, and the AGC voltage VAGC is a signal representative of an amplitude of mainly a desired reception signal. Therefore, for AGC of the high frequency amplifier 12 by the AGC voltage VOL, the gain of the differential amplifier 52 is set larger than that of the differential amplifier 51, and the differential amplifier at the stage where the input signal (reception signal SRX) is attenuated more is used. For the delayed AGC of the differential amplifiers 51 to 54, the differential amplifier in operation is made to have a maximum operation current.

Since attenuation by the attenuator circuits 42 to 44 is first effected and then amplification by the differential circuits 51 to 54 is effected, interference by the interference signal can be prevented. It is possible to conduct an optimum gain control depending upon the amplitudes of the interference signal and desired reception signal.

A high frequency gain can be manually adjusted if a control voltage manually and linearly changed is supplied to the logarithmic compression circuit 60A instead of the AGC voltage VOL or if a control voltage manually and linearly changed is added to the AGC voltage VOL.

[6] Summary

According to the above-described AGC circuit, AGC for the reception signal SRX can be conducted in a wide range from a fine level to a large level. Since a large reception signal SRX can be processed to such a degree corresponding to the attenuation amount of the attenuator circuits 42 to 44, the reception signal SRX from a small level to a large level can be processed while a low distortion and low noises are maintained.

Switching between the differential amplifiers 51 to 54 and controlling an operation current of a switched differential amplifier can be performed by using a negative feedback loop. Therefore, switching between the differential amplifiers and controlling the operation current can be made smoothly even at the boundaries of the ranges, and the gain of the high frequency amplifier 12 can be changed properly. Therefore, the AGC operation can have constant response characteristics independent from the amplitude of the reception signal SRX.

When the gain AV of the high frequency amplifier 12 is controlled, the control current Im having a strong correlation with the gain AV is controlled so that the very stable gain control is possible. Since the loop gain of not only the intermediate frequency amplifier stage AGC but also the high frequency amplifier AGC is stable, the AGC response characteristics can be set with high precision. Therefore, even a receiver for digital broadcasting which requires severe AGC response characteristics can obtain an excellent reception performance.

If the characteristics of the logarithmic compression circuit 60 are changed, the arbitrary gain change characteristics can be obtained correspondingly, broadening an application range. Since a difference between gain change characteristics is compensated by negative feedback, desired gain change characteristics can be obtained even if a variable gain circuit is constituted of circuits having quite different characteristics, such as the attenuator circuits 42 to 44 and the differential amplifiers 51 to 54 whose operation currents I51 to I54 being controlled.

According to the present invention, it is possible to control the level of an input signal in a wide range from a fine level to a large level. Furthermore, the level control from a small level to a large level is possible while a low distortion and small noises are maintained.

Switching between variable gain amplifiers and between attenuator circuits can be performed smoothly through negative feedback and the gain change characteristics can be made constant. Therefore, constant AGC response characteristics can be obtained independently from the amplitude of a reception signal.

1. An automatic gain control (AGC) circuit comprising:
a plurality of attenuation circuits connected in series relative to a reception signal;
a plurality of variable gain amplifiers that receive the reception signal and each output signal from the plurality attenuation circuits, respectively;
a signal deriving circuit connected to the output signals of the plurality of variable gain amplifiers for deriving a level-controlled output signal; and
a control current generating circuit for generating a control current having a predetermined characteristic from first and second AGC voltages, wherein
the control current from the control current generating circuit is supplied to the plurality of variable gain amplifiers as a control signal for switching an operation and a gain thereof, and
the control current is produced by feedback by the control current generating circuit.

2. An automatic gain control (AGC) circuit comprising:
a high-frequency amplifier configured with a variable gain amplifier;
a first conversion circuit for converting a first AGC voltage to a first control current having a predetermined characteristic; and
a second conversion circuit for converting a second AGC voltage to a second control current having said predetermined characteristic, wherein
the first and second control currents are fed back to the variable gain amplifier configuring the high-frequency amplifier as a gain control signal.

3. The AGC circuit as cited in claim 2, wherein
the first conversion circuit comprises a first logarithmic compression circuit for logarithmically compressing the first AGC voltage to the first control current;
the second conversion circuit comprises a second logarithmic compression circuit for logarithmically compressing the second AGC voltage to the second control current; and
the variable gain amplifier configuring the high-frequency amplifier comprises a differential amplifier, wherein
a constant current of a constant current source configuring the differential amplifier is set to the first and the second control currents outputted from the first and second logarithmic compression circuits.

4. The AGC circuit as cited in claim 2, or claim 3, wherein
the whole AGC circuit is fabricated in a form of a one-chip IC.
